(19) United States
(12) Patent Application Publication
(10) Pub. No.: US 2015/0007796 A1
(43) Pub. Date: Jan. 8, 2015

(54) FUEL DISTRIBUTOR BAR

(71) Applicant: BENTELER AUTOMOBILTECHNIK GMBH, Paderborn (DE)

(72) Inventors: Friedrich Schulte, Paderborn (DE); Damian Zwiener, Paderborn (DE)

(21) Appl. No.: 14/376,302

(22) PCT Filed: Jan. 31, 2013
(86) PCT No.: PCT/DE2013/100035

§ 371 Date: Aug. 1, 2014

(30) Foreign Application Priority Data
Feb. 2, 2012 (DE) 10 2012 001 926.2

(51) Int. Cl. F02M 63/02

(52) U.S. Cl. CPC F02M 63/0275
USPC 123/456

(57) ABSTRACT

A fuel distributor bar for petrol is closed at the end by a stopper, wherein the stopper is inserted into the fuel distributor bar and is soldered thereto. The stopper and the fuel distributor bar are designed for an operating pressure of 200 to 800 bars. A pipe wall of the fuel distributor bar is provided with a return internally at the end for said purpose. The stopper is in engagement with the return and has a projection that terminates flush with the pipe wall of the fuel distributor bar.

The invention relates to a tubular fuel distributor bar, which is closed on its end side with a stopper, which is inserted into the fuel distributor bar and is soldered to the thereto.

Fuel is usually distributed to individual cylinders of the internal combustion engine through a tubular fuel distributor bar which is arranged close to the cylinder head and is fastened thereto by means of fastening elements. At the same distances as the cylinders, openings are arranged on the fuel distributor bar into which injection valves are inserted, which inject the fuel into the combustion chamber of the respective cylinder. At the end side the fuel distributor bar is closed with stoppers. Either the fuel supply is also integrated in the fuel distributor bar in one of these stoppers or the fuel distribution occurs'at another site of the fuel distributor bar.

Usually gasoline or diesel is used as fuel. Today a direct injection is performed into the combustion chamber of the respective cylinder also in diesel motors as well as in modern gasoline motors. However, the operating pressures on the fuel distributor bar differ significantly between diesel and gasoline. The required pressure for the diesel direct injection is relatively high. In a so-called common rail technology the pressure is about 1800 bar and increases to 2500 bar in a so-called pump-nozzle-technology. In the case of gasoline the usual working pressures are about 1 to 100 bar. Only in the case of a high pressure direct injection into a gasoline motor the fuel distributor bar has to be configured to an operating pressure of 200 to 800 bar. This results in constructive differences in the fuel distributor bar depending in whether the fuel distributor bar is used for a diesel motor, a gasoline motor or a gasoline motor with modern direct injection at relatively high pressure.

DE 10 2009 029 219 A1 discloses a fuel distributor bar for a diesel combustion engine. This fuel distributor bar is a solid fuel distributor bar in which all connections for the injection valves are molded on in one piece. At the end side stoppers are screwed into the fuel distribution line via a threading. The wall thickness of the fuel distribution line increases so that a tube wall of the fuel distributor bar is provided on its end side with an inside return and the stopper engages with the return and the threading is introduced in the tube wall with the return.

A similar construction of a fuel distributor bar for diesel combustion engines is disclosed in DE 101 62 203 A1. In a one-piece forged tube, a tube wall of the fuel distributor bar is provided on the end side with an inside return and a threading into which the stopper is screwed.

Such great wall thicknesses are not available in fuel distributor bars for gasoline, because here the entire fuel distributor bar is made of a relatively thin-walled tube due to the significantly lower operating pressures. At an injection pressure of less than 10 bar a generic fuel distributor bar is for example made of a stainless steel with a wall thickness of below 1 mm. Typically stoppers are soldered with the fuel distributor bar on its end side. This construction is not possible in a fuel distributor bar for a high-pressure diesel application because it does not withstand the operating pressure of more than 1800 bar.

DE 100 42 540 C1 discloses a thin-walled fuel distributor bar, which is made of an inner tube and a reinforcement surrounding the inner tube. On its end side the inner tube is closed with a stopper, on the other side a stopper is arranged, which is inserted in a connection line. The stoppers are inserted into the inner tube and connected with the inner tube by a material connection.

DE 10 2008 044 923 A1 also shows a fuel distributor bar which on its end side is closed with a respective stopper. Both stoppers are configured a cup-like deep drawn or sheet metal component, inserted in to the fuel distributor bar and like other connection components soldered with the fuel distributor bar.

So long as the operating pressure in fuel distributor bars for gasoline motors is in a range of a few bar, the above described construction is operationally safe. However, when demands are placed on the fuel distributor bar for gasoline to safely withstand an operating pressure of 200 to 800 bar problems arise, which however do not justify switching to the forging solutions of the diesel field because for this the operating pressure is not high enough. In particular the joining site between stopper and fuel distributor bar is exposed to different loads. The loads consist of a pushing force, which results from the inner pressure of the fuel tank onto the inner surface of .the stopper, and a pulling force in the joining site which results from the interior pressure in the tube onto the inner surface of the tube. As a consequence the force flux in the joining site is deflected and thus causes increased tensions in the joining site.

It is therefore an object of the present invention to configure a generic tubular fuel distributor bar, which is closed at its end side with a stopper, which is inserted into the fuel distributor bar and is soldered with the fuel distributor bar, to an operating pressure of 200 to 800 bar.

The invention solves this object with the features of claim 1. According to this, in a tubular fuel distributor bar which is closed at its end side with a stopper, which is inserted into the fuel distributor bar and is soldered with the fuel distributor bar, a tube wall of the fuel distributor bar is provided at the end side of the fuel distributor bar with a return and the stopper engages with the return. This means that the tube wall of the fuel distributor bar is processed at the ends to be closed so that after the joining the thickness of the tube wall of the fuel distributor bar continues in the stopper. For this the stopper has an projection on the side to be introduced into the fuel distribution line, so that an inner diameter of the stopper at this site equals an inner diameter of the fuel distributor bar without return. In this way the projection of the stopper ends flush with the tube wall of the fuel distributor bar. As a result the force flux is not deflected. In the fuel distributor bar and the stopper no stiffness step is generated and with this no notch effect of the joining site. In a particular embodiment, the stopper is provided on its outer circumference with a groove, which lies in the fuel distributor bar for receiving a solder ring. The projection on the stopper prevents that the solder flows into the interior of the fuel distributor bar. The solder remains in the region of the groove and the directly adjoining flat regions of the stopper, thereby ensuring that sufficient solder is available for a materially bonding connection of the stopper and the fuel distributor bar. In a further preferred embodiment, a through passage for fuel is formed in the stopper, wherein preferably the through passage has at least two different-sized diameters. For an improved handling the stopper has at its outer circumference a marking, which lies outside the fuel distributor bar. The stopper and the fuel distributor bar are configured to an operating pressure of 200 to 800 bar and are usually used for gasoline fuel.

In the following, the invention is described in more detail by way of the Figures. It is shown in:

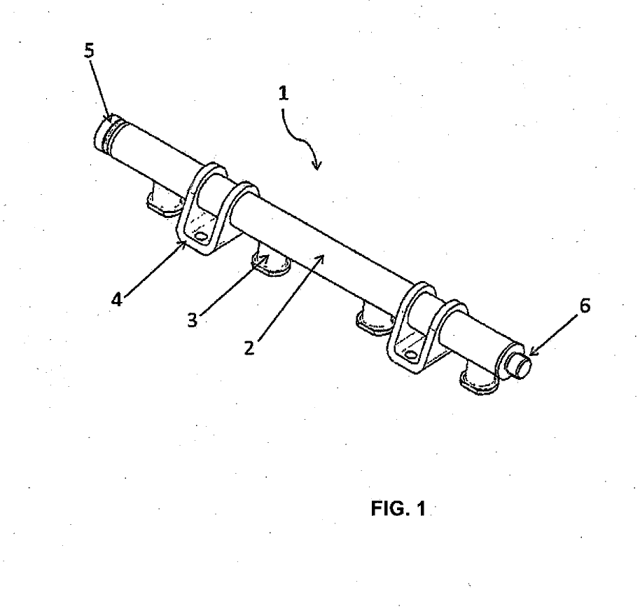

FIG. 1 a top view onto a fuel distributor bar accordion to the invention (1),

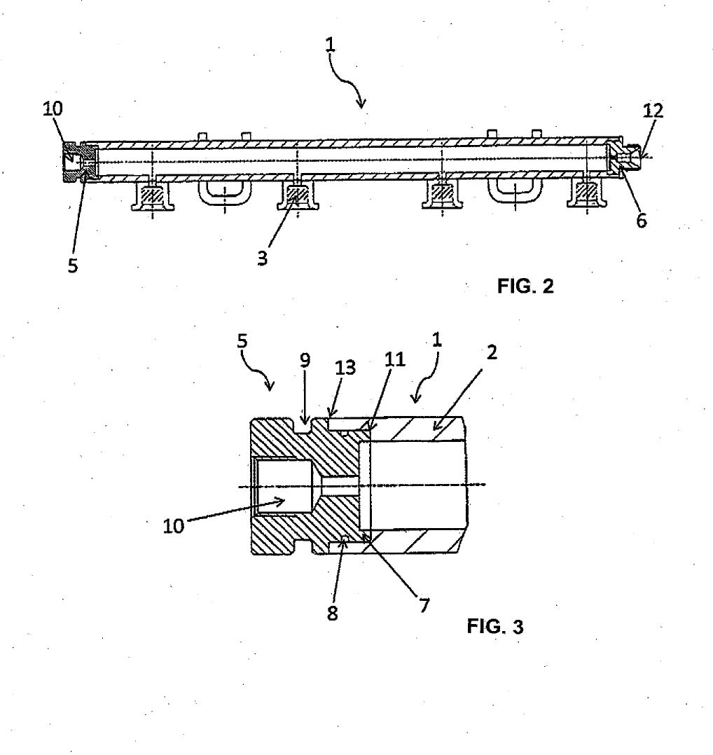

FIG. 2 a longitudinal section through the fuel distributor bar (1) according to the invention,

FIG. 3 a detail view of the connection of stopper (5) of FIG. 2 with the fuel distributor bar (1),

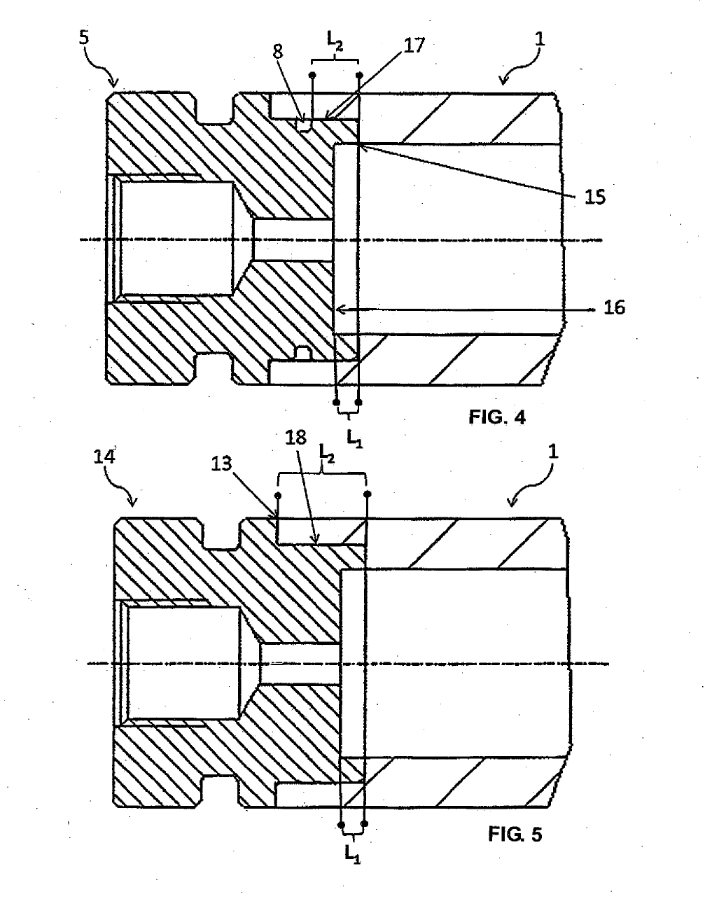

FIG. 4 shows the stopper (5) of FIG. 3 enlarged with a drawn in length proportion

FIG. 5 shows an alternative stopper (14) with drawn in length proportion.

In FIG. 1 shows the fuel distributor bar (1) with a tube wall (2), connection sockets (3) for injection valves and fasteners (4) for fastening on a combustion engine in a top view. On its end side, the fuel distribution (1) rail is closed with two different stoppers (5) and (6).

FIG. 2 shows a longitudinal section through the fuel distributor bar (1) according to the invention. Fuel can be supplied through the stopper (6) via the through passage (12). Via a not shown high-pressure pump an operating pressure of 200 to 800 bar is established in the fuel distributor bar (1). The through passage (12) has different diameters, i.e., the diameter decreases in the direction of the fuel distributor bar (1). This serves for slowing down and calming the inflowing fuel. In the stopper (5) an opening (10) is located in which a not shown pressure sensor is arranged which monitors the pressure in the interior of the fuel distributor bar (1). The fuel is supplied to not shown cylinders of the combustion engine via the connection sockets (3). As an alternative both stoppers can have a through opening for fuel.

FIG. 3 shows the stopper (5) and the connection with the fuel distributor bar (1) in detail. The stopper (5) has a stop (13). The stopper (5) is inserted up to this stop (3) into the fuel distributor bar (1). On its end side, the stopper (5) has an projection (7), which is located in the interior of the fuel distributor bar (1). The fuel distributor bar (1) is processed in its end region so that a return (11) is introduced in the tube wall (2) of the fuel distributor bar (1). The projection (7) of the stopper (5) engages this return (11). The projection (7) ends flush with the tube wall (2). In the region of the projection (7) the inner diameter of the stopper (5) thus corresponds to the inner diameter of the fuel distributor bar (1) without return (11). The stopper therefore continues the wall thickness of the fuel distributor bar (1). This shifts the joining site from a relatively highly stressed region. On the outer circumference of the stopper (5) a circumferential groove (8) is worked in within the fuel distributor bar (1). The projection (7) ensures that the solder remains in the region of the groove (8) and the joining site bordering thereon and does not uncontrollably migrate into the interior of the fuel distributor bar (1) and thus weakens the joining site. The return (11), the projection (7) and the circumferential groove (8) are also present on the stopper (6). However, while in the through opening (12) of the stopper (6) the fuel is sup fuel distributor bar lied into the fuel distributor bar (1), a pressure sensor is arranged in the opening (10) of the stopper (5). As a consequence the elements relevant for the invention are realized in both stoppers (5, 6) and on both ends of the fuel distributor bar (1). Because the stoppers (5, 6) however are not constructed completely identical the stopper (5) has on its outer circumference a marking (9), which lies outside the fuel distributor bar (1). The marking (9) aids a robot in distinguishing the two stoppers (5) and (6) so that during mounting of the fuel distributor bar (1) the stoppers (5, 6) are not mixed up. Alternatively a fuel distributor bar according to the invention can also be closed on both sides with identical stoppers with and without through passage for fuel.

Finally, the tension distribution at the joining site or the joining seam is an important criterion for the durability of the fuel distributor bar (1). Comprehensive strength tests have shown that a defined length ratio between an inner length L₁ of the projection (7) and an outer length L₂ on the stopper (5, 14) should not be fallen below. Hereby FIG. 4 shows an enlargement of the stopper of FIG. 3. On one hand an important factor is the inner length L₁ of the projection (7). L₁ is measured on the inner diameter of the stopper (5), i.e., from an projection end (15) of the projection (7) to a bottom (16) of the stopper (5). L₂ is measured on the outer length of the stopper (5). Stopper (5) has a groove (8), which receives a not further shown solder ring. The groove (8) weakens the stopper (5). In addition a solder surface (17) of the groove (8) up to the projection end (15) of the projection (7) forms the carrying connection. The strength of the connection results from this solder surface (17).

When the stopper (5) is thus joined via the solder ring with the tube wall (2) of the fuel distributor bar (1), L₂ is measured from the groove (8) to the projection end (15). When the thus determined outer length L₂ of the solder surface (17) on the stopper (5) is divided by the inner length L₁ of the projection (7) the ratio should be greater than or equal to 2, i.e., L₂:L₁≧2.

As an alternative to the solder ring, the stopper may also be pasted with a solder. in this case a groove for receiving the solder ring is not required. Such an embodiment is shown in FIG. 5. In the here shown stopper (14) a solder surface (18) extends from the stop (13) to the projection end (15). As in the case of the stopper (5), L₂ is also measured in this case from the projection end (15) to the bottom (16). Also in this case the relationship L₂:L₁≧2 applies for an optimal tension ratio.

In FIGS. 3 to 5 D1 designates the inner diameter of the fuel distributor bar (1) without return (11) and the inner diameter of the stopper (5, 6). The inner diameter D1 of the stopper (5, 6) in the region of the projection (7) corresponds to the inner diameter D1 of the fuel distributor bar (1) without return (11). D2 designates the outer diameter of the projection (7) or the inner diameter of the tube wall (2) of the fuel distributor bar (1) in the region of the return (11). D3 designates the outer diameter oft the fuel distributor bar (1).

### LIST OF REFERENCE SIGNS

1 fuel distributor bar
2 tube wall
3 connection socket
4 fastener
5 stopper
6 stopper
7 projection
8 groove
9 marking
10 opening
11 return
12 through passage
13 stop
14 stopper
15 projection end
16 bottom
17 solder surface
18 solder surface
L1 inner length
L2 outer length

1-8. (canceled)

9. A tubular fuel distributor bar having a tube wall, with an inside provided with a return at an end of the tubular fuel distributor, said tubular fuel distributor bar comprising a stopper having a side provided with a projection and being inserted into the end of the fuel distributor bar so as to engage with the return, and being soldered with the tubular fuel distributor bar, wherein an inner diameter of the stopper in a region of the projection equals an inner diameter of the fuel distributor bar without the return and the projection of the stopper ends flush with the tube wall of the fuel distributor bar.

10. The tubular fuel distributor bar of claim 9, wherein a groove is provided on an outer circumference of the stopper for receiving a solder ring, said groove being situated inside the fuel distributor bar.

11. The tubular fuel distributor bar of claim 9, wherein a ratio between an outer length of the stopper and an inner length of the projection of the stopper is L2:L1≧2.

12. The tubular fuel distributor bar of claim 9, wherein the stopper is provided with a through passage for fuel.

13. The tubular fuel distributor bar of claim 12, wherein the through passage has at least two different diameters.

14. The tubular fuel distributor bar of claim 9, wherein a marking is provided on an outer circumference of the stopper, said marking being situated outside the fuel distributor bar.

15. The tubular fuel distributor bar of claim 9, wherein the stopper and the fuel distributor bar are configured for an operating pressure of 200 to 800 bar.

16. The tubular fuel distributor bar of claim 9, wherein the fuel is gasoline.
